(19) United States
(12) Patent Application Publication
(10) Pub. No.: US 2008/0004961 A1
(43) Pub. Date: Jan. 3, 2008

(54) System, method and apparatus for cooperative marketing

(76) Inventor: Chihkai John Tang, St. Petersburg, FL (US)

Correspondence Address: LARSON AND LARSON, 11199 69TH STREET NORTH, LARGO, FL, 33773, US

(21) Appl. No.: 11/479,333

(22) Filed: Jun. 30, 2006

(51) Int. Cl. G06Q 30/00

(52) U.S. Cl. 705/14

(57) ABSTRACT

A computer based method for connecting at least two cities in a cooperative marketing system includes establishing suppliers in at least one supplying city; establishing marketers in at least one marketing city; shipping goods from the suppliers to the marketers; marketing the goods by the marketers in the marketing city; and managing a flow of goods, an inventory of goods and a flow of payments by a city coop manager process operating on a computer system.

### BACKGROUND OF THE INVENTION

1. Field of the Invention

This invention relates to the field of cooperative marketing and more particularly to a system and method for matching individual suppliers with small business marketers.

2. Description of the Related Art

In many cities or centers of population, there are many smaller manufacturers or suppliers that produce very good products but have limited distribution and marketing means to their disposal, thereby limiting the overall market for their quality goods. At the same time, there are many other cities or centers of population that have a very health economy with many consumers who would eagerly purchase the products from the aforementioned manufacturers or suppliers, if there was a conduit for marketing their products to those consumers.

Presently, there are many large marketing and retail companies such as Walmart that provide a marketplace for many manufacturers and suppliers. Unfortunately, companies such as Walmart only source from a small set of larger manufacturers and suppliers. The don't providing an outlet for a small manufacturer or supplier. Furthermore, since these companies are mega-sized and have a corporate headquarters most likely located in a different state, the profits from sales of goods does not benefit the local community as would sales of goods at a local small business.

What is needed is a system and method that will join a supplying population center that has many smaller suppliers with a consumer population center that has small businesses interested in marketing products from the smaller suppliers to consumers interested in those products, the method providing logistics and incentives for the joining of the suppliers with the small business marketers.

### SUMMARY OF THE INVENTION

One objective of the present invention is to provide a system and method whereby small suppliers in one city are coupled to small marketers in another city whereby the system and method manages the details of all operations between the suppliers and marketers.

Another objective of the present invention is to provide a city coop method whereby a government entity in a supplier city enlists suppliers to supply goods to a marketing city.

Another objective of the present invention is to provide a city coop method whereby a government entity in a marketing city enlists small business marketers to sell goods supplied by small suppliers from a supplier city.

Another objective of the present invention is to provide a framework in which small businesses in a marketing city can establish retail space and sell goods supplied by small suppliers from a supplier city.

In one embodiment, a city coop system for managing the supply, delivery and marketing of goods between at least two cities is disclosed including a server computer with a processor, a memory and a network interface, the network interface operatively coupling the server computer to a network. A database is operatively coupled to the server computer and a city coop management module operating on the server computer interfaces with the database. There is a first interface between the city coop management module and at least one supplier computer in a supplying city and a second interface between the city coop management module and at least one marketer computer in a marketing city. The city coop management module includes logic to manage supplier transactions from the supplier computers and marketer transactions from the marketer computers.

In another embodiment, a computer based method for connecting at least two cities in a cooperative marketing system is disclosed including: establishing suppliers in at least one supplying city; establishing marketers in at least one marketing city; shipping goods from the suppliers to the marketers; marketing the goods by the marketers in the marketing city; and managing a flow of goods, an inventory of goods and a flow of payments by a city coop manager process operating on a computer system.

In another embodiment, a method of doing business in which at least two cities are interfaced in a cooperative marketing system is disclosed including establishing suppliers in at least one supplying city; establishing marketers in at least one marketing city; shipping goods from the suppliers to the marketers; marketing the goods by the marketers in the marketing city; collecting payments from the marketers; retaining a percentage of the payments from the marketers; transferring a remainder of the payments from the marketers to the suppliers; and managing a flow of goods from the suppliers, an inventory of goods at the marketers and a flow of the payments.

In another embodiment, a computer program product for use with a computer system for connecting at least two cities in a cooperative marketing system is disclosed, the computer program product includes a computer usable medium having computer-readable code embodied in the medium, the computer-readable code includes computer readable code for interfacing over a network a city coop manager to supplier computers located in a supplier city and computer readable code for interfacing over the network the city coop manager to a plurality of marketer computers from a marketer city. There is computer readable code for storing logistics, inventory and payment information into a database and transactions acted upon by computer readable code in the city coop manager.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a data flow diagram of all embodiments of the present invention.

FIG. 2 illustrates an interconnection diagram of the first embodiment of the present invention.

FIG. 3 illustrates an interconnection diagram of a second embodiment of the present invention.

FIG. 4 illustrates a typical product and money flow of all embodiments of the present invention.

FIG. 5 illustrates a flow chart for initiating the methods of all embodiments of the present invention.

FIG. 6 illustrates a flow chart for organizing the marketing side of all embodiments of the present invention.

FIG. 7 illustrates a flow chart for organizing the supplying side of all embodiments of the present invention.

FIG. 8 illustrates a flow chart for the continuous process of all embodiments of the present invention.

FIG. 9 illustrates a flow chart for a special order process of all embodiments of the present invention.

FIG. 10 illustrates a sample product tracking table of all embodiments of the present invention.

FIG. 11 illustrates a typical computer system the first embodiment of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures. Throughout this specification, the word “city” is used to reference a center of population and has the same meaning as town, prefecture, state, locality, municipality, and the like, in that it is a geographic collection of people and building structures. Throughout this specification, “supplying city” refers to a population center that has a group of small suppliers or manufacturers that produce goods and “marketing city” refers to a population center that has a group of small businesses that are interested in marketing these goods. Throughout this specification, “city coop manager” refers to an entity, a person or an organization that manages various aspects of the interface between the suppliers and the marketers. “City coop manager” also refers to the software that manages the city coop operation, providing support for the city coop manager person(s).

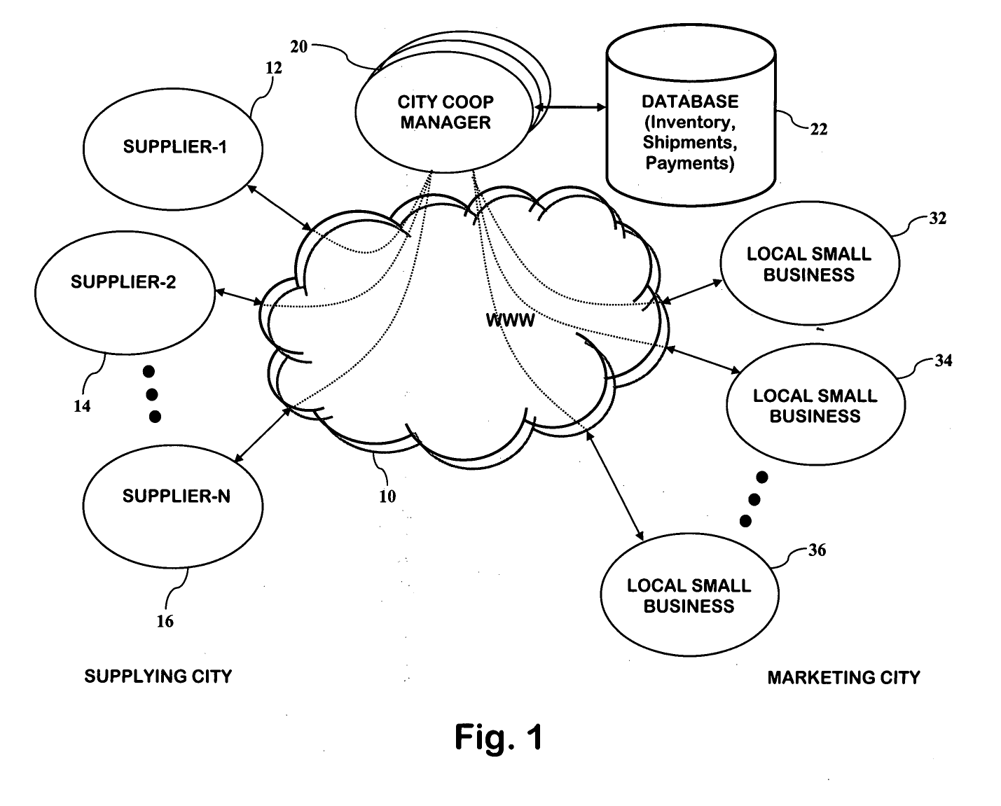

Referring to FIG. 1, a data flow diagram of all embodiments of the present invention is shown. This diagram shows several suppliers 12/14/16 from a supplying city in communication with a city coop manager 20 through a network 10, which is preferably the World Wide Web. The city coop manager 20 is interfaced with a database 22 for keeping track of material logistics, shipments, payments, etc. Also, several small businesses 32/34/36 are also in communications with the city coop manager 20.

The methods and apparatus of the present invention support a business model that enhances the exchange of goods between a supplying city having several small suppliers of the goods and a marketing city having an outlet for the goods as well as several small businesses that can market the goods. Before the present invention, a supplier in a typical supplying city found it difficult to marketing their goods in a typical marketing city due to the high costs of shipping and marketing along with other factors such as understanding the export/import process, taxes, money exchanges, legal issues, etc. For example, a small supplier of office furniture in Taipei having a product line consisting of several models of desks could not afford to market and sell the desks in Tampa, Fla. The supplier would need staff with expertise in export, taxes, logistics, etc. Additionally, the supplier would need to advertise in the marketing city.

The methods of the present invention support a process whereby a political or grass-roots organization in each of the supplying city and the marketing city develop a relationship and process for enabling the supply of goods from several small suppliers/manufactures and the delivery of the goods to small business marketers in the marketing city where they are sold to consumers. For example, the office furniture supplier above, a lamp manufacturer, a chair manufacturer and a phone manufacturer are coupled with three small business marketers in the marketing city. The methods and apparatus of the present invention manage the logistics of transporting these goods to the marketers and the resulting transfer of monies when the goods are sold. In this example, each manufacturer might not have enough goods to fill an entire shipping container, but taken together, the four manufacturers may have sufficient inventory to completely fill a container. The city coop manager manages the shipment, taxes, logistics, payments, etc.

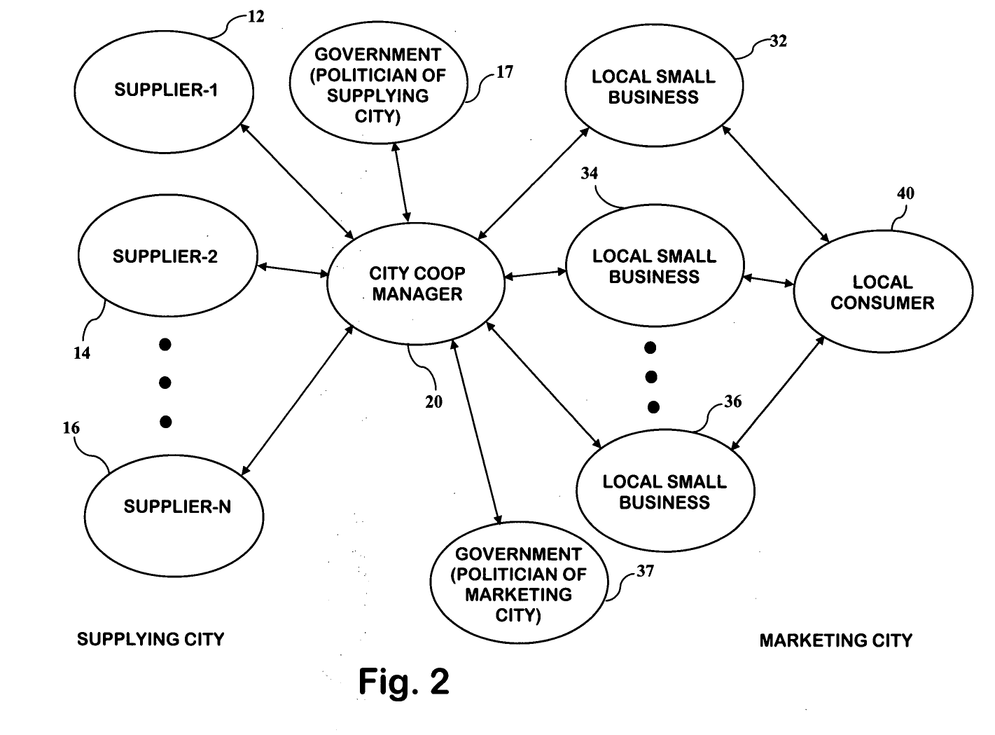

Referring to FIG. 2, an interconnection diagram of the first embodiment of the present invention is shown. This diagram shows several suppliers 12/14/16 from a supplying city in communication with a city coop manager 20. The city coop manager 20 also interfaces with several small businesses 32/34/36 and the small businesses 32/34/36 interface with the local consumer base 40. The city coop manager 20 is the interface between the suppliers 12/14/16 and the small business marketers 32/34/36 providing, for example, support, material logistics, currency conversions, money transfers, etc. In this way, each suppliers 12/14/16 need not have a direct relationship with many small business marketers 32/34/36 and each small business marketer 32/34/36 need not have a direct relationship with many suppliers 12/14/16. Also shown in FIG. 2 are governments of the supplying city 17 and of the marketing city 37. In some embodiments, the government entities 17/37 are involved to provide incentives to increase business, and hence, employment, tax base, etc. In these embodiments, a local politician from the supplying city 17 works with the city coop manager 20 to help provide contacts and to provide incentives to the small suppliers 12/14/16 (for example, tax breaks). Also, in these embodiments, a local politician from the marketing city 37 works with the city coop manager 20 to help provide contacts and to provide incentives to the small businesses 32/34/36 (for example, tax breaks, retail space, advertising).

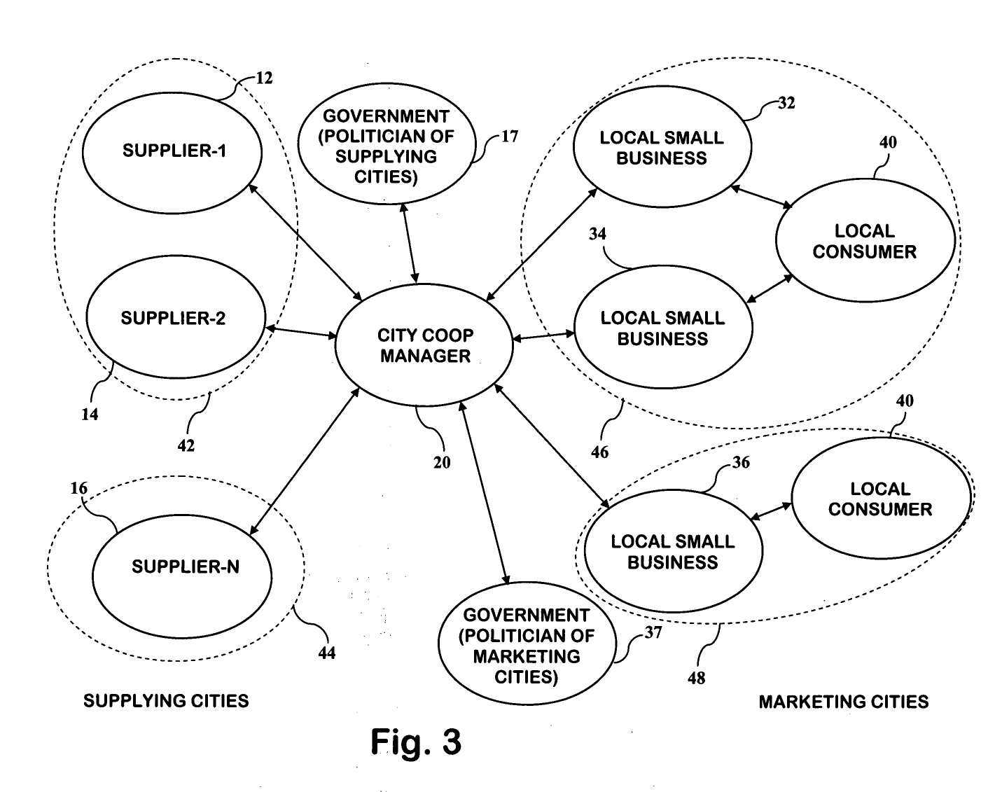

Referring to FIG. 3, an interconnection diagram of a second embodiment of the present invention is shown. This diagram shows several suppliers 12/14/16 from two supplying cities (42/44) in communication with a city coop manager 20. The city coop manager 20 also interfaces with several small businesses 32/34/36 in two marketing cities 46/48 and the small businesses 32/34/36 interface with the local consumer base 40 in their cities. The methods of the present invention work with any number of cities, for example, Taipei and Linko in Taiwan for supplying cities 42/44 and Clearwater and St. Petersburg Fla. for marketing cities 46/48.

In some embodiments, a local politician from the supplying city 17 works with the city coop manager 20 to help provide contacts and to provide incentives to the small suppliers 12/14/16 (for example, tax breaks). Also, in some embodiments, a local politician from the marketing cities 37 works with the city coop manager 20 to help provide contacts and to provide incentives to the small businesses 32/34/36 (for example, tax breaks, retail space, advertising).

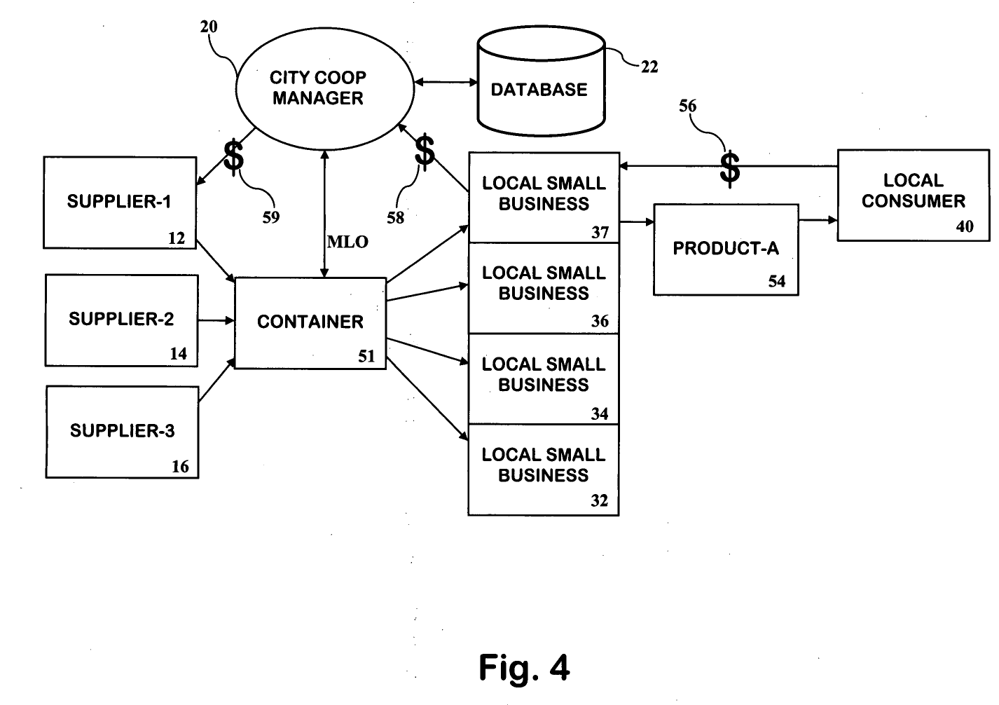

Referring to FIG. 4, a typical product and money flow of all embodiments of the present invention is shown. This exemplary system is greatly simplified to three suppliers 12/14/16 and four local small marketing businesses 32/34/36/37. Suppliers 12/14/16 send and receive transactions to and from the city coop manager 20 to schedule a combined shipment of goods in a single or multiple containers 51 from the supplying city to the marketing city. In this way, products from several suppliers 12/14/16 are combined to efficiently occupy space within the containers 51 and provide a low cost method of transporting the supplier's 12/14/16 goods to the new marketplace. In one embodiment, the goods are provided on consignment, e.g., there is no payment for the goods until they are sold by the small business marketers 32/34/36/37. The container 51 is delivered to the retail location of the small business marketers 32/34/36/37. In one embodiment, the small business marketers 32/34/36/37 share a common retail location such as a mall. In one embodiment, the mall is provided by the local government or city coop manager 20 as an incentive to provide a homogeneous location for the small business marketers 32/34/36/37. Once delivered, the goods are unpacked from the container 51 and distributed to the small business marketers 32/34/36/37. As an example of a transaction, a product, Product-A 54 is sold to a local consumer 40 and the local consumer 40 pays the small business marketer 37 with local currency 56. At some time in the future, the small business marketer 37 makes payments with a payment transaction 58 for all products sold during a period of time (e.g., one month), keeping a portion of the gross sales for themselves to pay costs and, hopefully, to provide a profit. The payment transactions or payments 58 are tracked and managed by the city coop manager 20 using the database 22. In some embodiments, the city coop manager 20 retains a share of the payment. At some time later, the city coop manager 20 sends a payment transaction 59 to the supplier 12 who supplied the sold product (Product-A). Preferably, this payment is made in the local currency of the supplier 12. As can be seen, any given supplier 12/14/16 can supply products to one or more of the small business marketers 32/34/36/37. Each product delivered it tracked by the city coop manager 20 and when payment is made 58, the payment is reconciled in this tracking system, thereby providing detail reporting showing which products have sold and which products are still in inventory at the small business marketers 32/34/36/37.

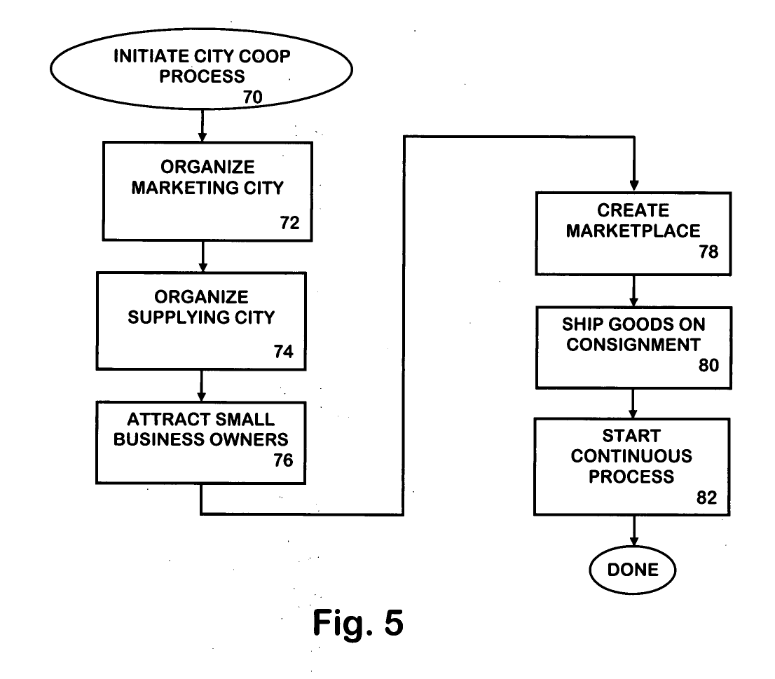

Referring to FIG. 5, a flow chart for initiating the methods 70 of all embodiments of the present invention is shown. The process begins with organizing the marketing city 72 and organizing the supplying city 74. This includes finding suppliers and making agreements with them to provide goods to the marketing city 74. In the marketing city, small business owners are attracted to the business model 76 and a marketplace is established 78. In the preferred embodiment, a common marketplace is established 78, for example, a mall or other structure designed to house the small business marketers 32/34/36/37. This type of combined structure provides for common marketing and advertisement, local tax breaks and improved product delivery logistics. The structure can be privately owned or owned and/or funded by the marketing cities. Once these are in place, the process starts with an initial shipment of goods 80, preferably on consignment. Now the continuous process proceeds 82.

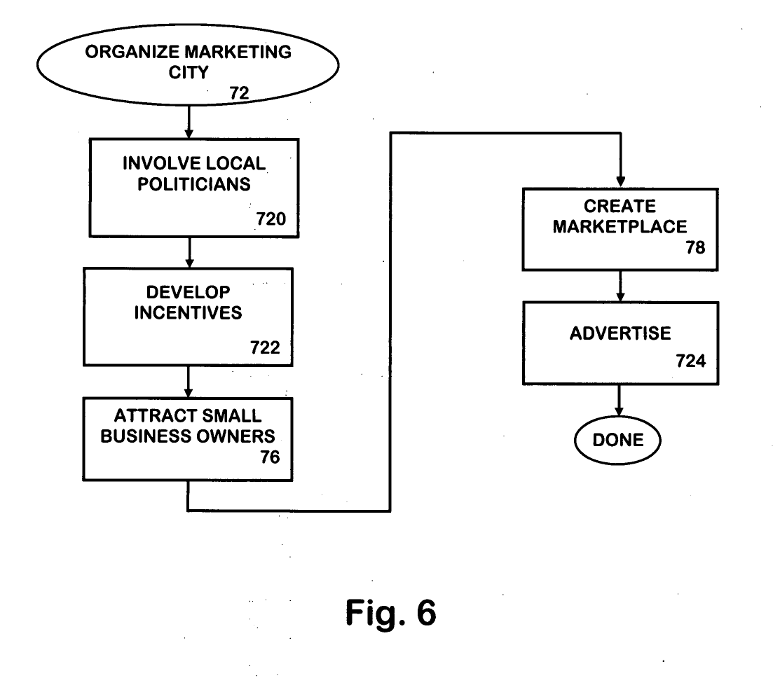

Referring to FIG. 6, a flow chart for organizing the marketing side 72 of all embodiments of the present invention is shown. It is preferred to involve local politicians 720 (e.g., a mayor). In some embodiments, the local politicians help the process by providing contacts and by developing incentives 722 including, for example, tax breaks and providing the common marketplace. The small business owners are attracted to the business model 76 and a marketplace is established 78. In the preferred embodiment, a common marketplace is established 78, for example, a mall or other structure designed to house the small business marketers 32/34/36/37. This type of combined structure provides for common marketing and advertisement, local tax breaks and improved product delivery logistics. The structure can be privately owned or owned and/or funded by the marketing cities. Once these are in place, the local government and/or the marketers 32/34/36/37 can cooperatively advertise their products 724.

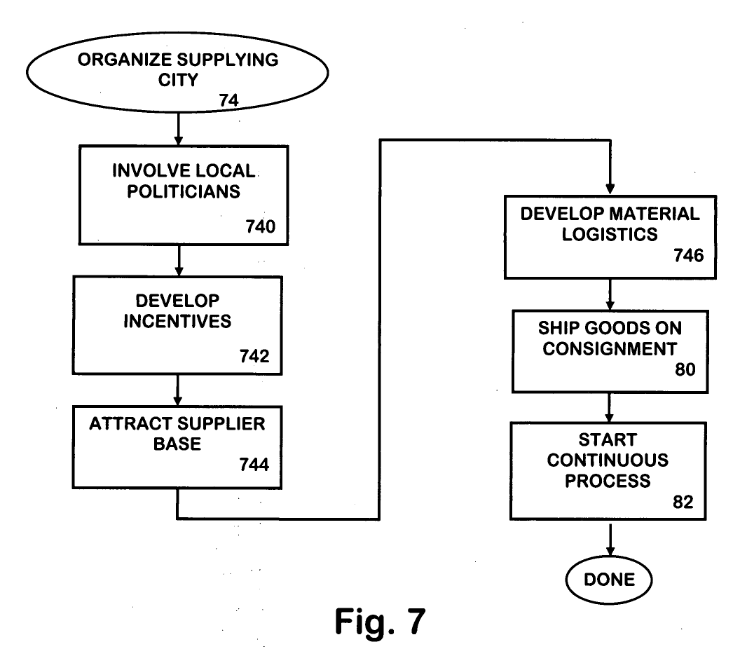

Referring to FIG. 7, a flow chart for organizing the supplying side 74 of all embodiments of the present invention is shown. It is preferred to involve local politicians 740 (e.g., a mayor). In some embodiments, the local politicians help the process by providing contacts and by developing incentives 742 including, for example, tax breaks. Suppliers are attracted 744 and agreements are made to provide goods to the marketing cities. The city coop manager 20 develops material logistic plans 746 to efficiently ship goods from the suppliers 12/14/16 to the marketers 32/34/36/37 and a starting quantity of goods are shipped, preferably on consignment 82. Now, the continuous process can proceed 80.

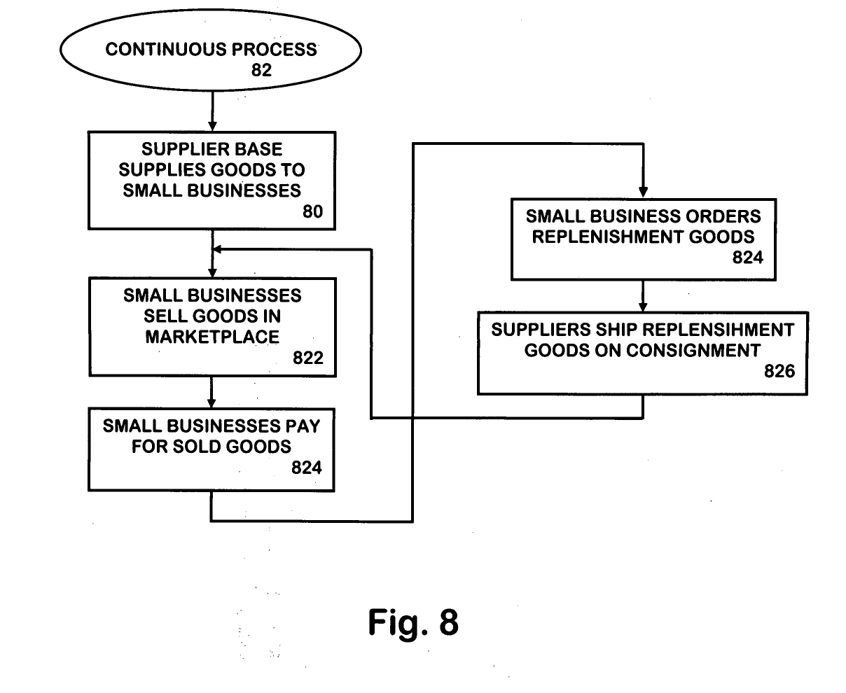

Referring to FIG. 8, a flow chart for the continuous process 82 of all embodiments of the present invention is shown. As discussed in FIG. 7, an initial supply of goods is shipped to the marketers 80. The marketers sell the goods, preferably in the mall or structure described previously 822. It is anticipated that the marketers can sell the goods to local consumers 40 as well as any consumer and may even sell the goods through the internet to any consumer. At some time after the sale, the marketers pay for the sold goods 824. It is preferred that the payments for the goods be combined for a time period (e.g., one month) and transferred to the city coop manager 20 for all goods sold during that time period. Periodically, the marketer orders goods to replenish what was sold 824. It is also preferred that these orders go to the city coop manager 20 for consolidation, tracking and logistics. It is also anticipated that the city coop manager 20 tracks the goods sold when payments are made and automatically orders replacement stock from the suppliers. In response to the orders, replenishment goods are shipped from the suppliers to the marketers, preferably on consignment 826.

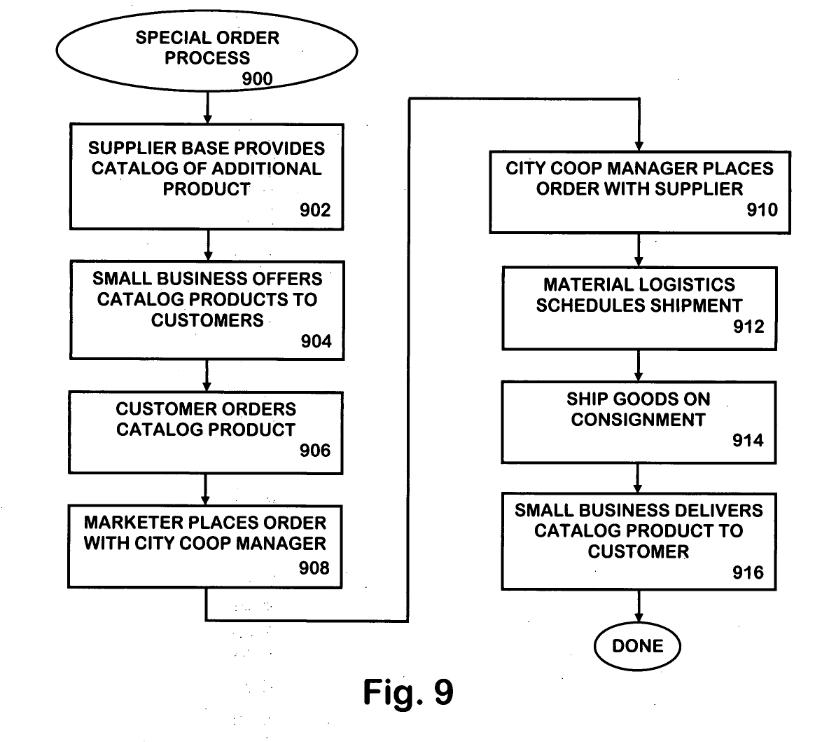

Referring to FIG. 9, a flow chart for a special order process 900 of all embodiments of the present invention is shown. For many types of products, it is not feasible to carry every item in every color that a supplier makes. For example, an office furniture supplier has twelve sizes of book cases, each in four different wood grains or colors. For just this line of product, the marketer would need to inventory 48 different book cases. Instead, the marketer stocks a preferred subset of book cases in the most popular wood grains and the supplier base provides a catalog of additional products 902, for example, a catalog with all 48 combinations. The marketer then showcases the stocked book cases and offers the catalog products to their customers 904. In response to the customer ordering a product from the catalog 906, an order is sent to the city coop manager 908 and the city coop manager 20 later orders the product from the supplier 910 and handles the material logistics to schedule the shipment of the product 912. The product is then, preferably, shipped on consignment 914 and eventually delivered to the customer 916.

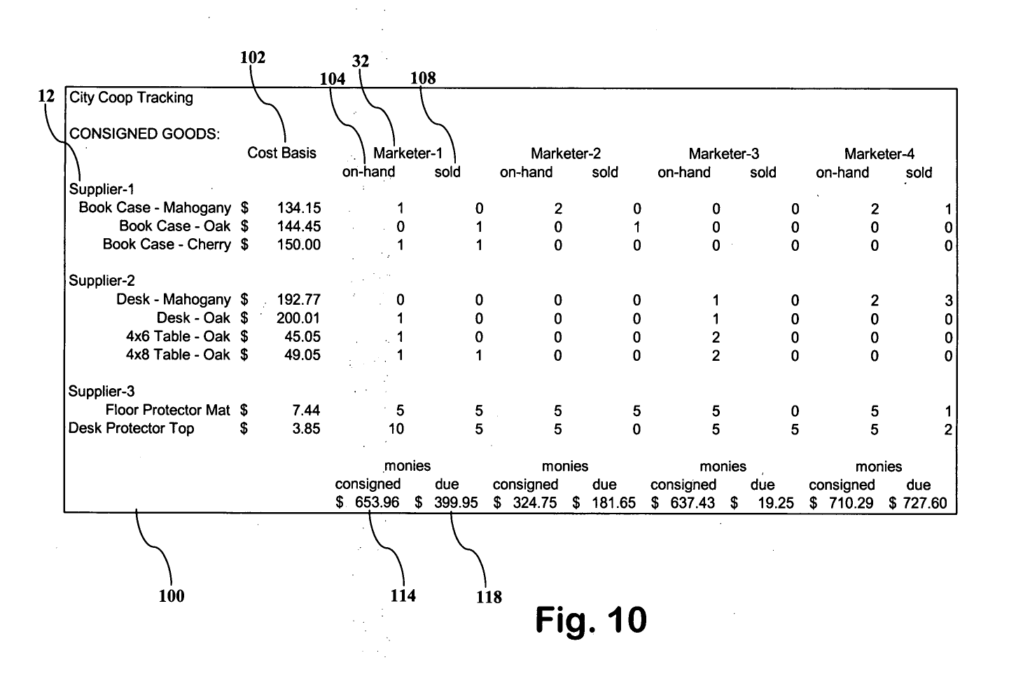

Referring to FIG. 10, a sample product tracking table of all embodiments of the present invention is shown. Although there is much more data to be tracked by the city coop manager 20, the table 100 shows an example of how inventories and sold goods are tracked. In this simplified example, there are three suppliers (supplier-1, supplier-2 and supplier-3) and four marketers (marketer-1, marketer-2, marketer-3 and marketer-4). A list of goods supplied by that supplier is shown under each supplier, next to which is the cost basis for those good in the Cost Basis column 102. For example, the cost basis for the Book Case—Mahogany from Supplier-1 12 has a cost basis of $134.15. For each marketer, records are kept regarding the quantity of each good on hand and the quantity sold during the current period. In this example, marketer-1 32 has one Book Case Mahogany on-hand and has sold one Book Case—Oak and one Book Case—Cherry. At the bottom of the table are totals of amount consigned and amount due for each marketer. For example, marketer-1 32 has a total of $653.96 consigned 114 and has sold $399.95 this period 118 and therefore owes that amount. Again, this is a sample of the data that is tracked by the city coop manager 20 and such data includes, but is not limited to: inventory on consignment, inventory sold, shipment information, return goods information, contact information, contract data and payment information.

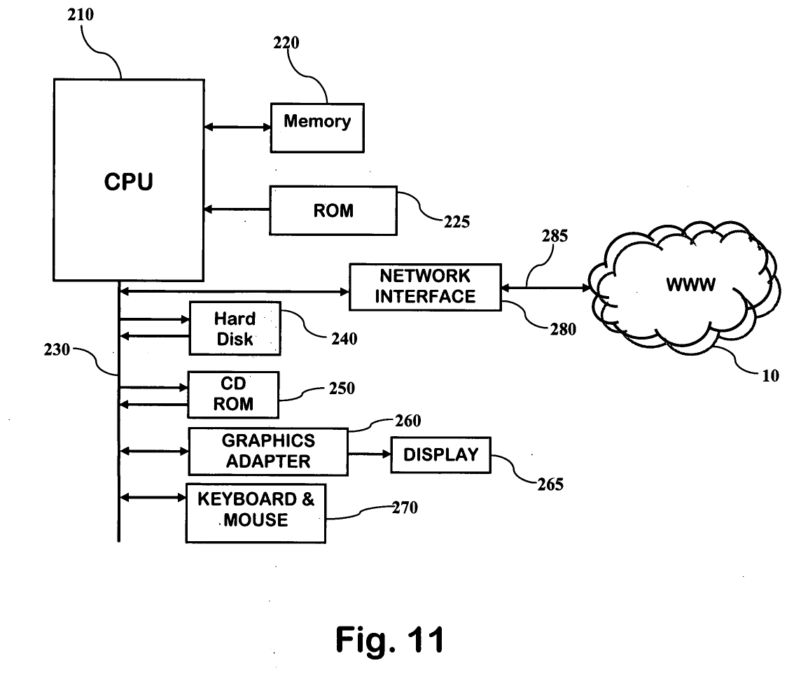

Referring to FIG. 11, a typical computer system the first embodiment of the present invention is shown. Although shown in its simplest form, having a single processor, many different computer architectures are known that accomplish similar results in a similar fashion and the present invention is not limited in any way to any particular computer system. The present invention works well utilizing a single processor system as shown in FIG. 11, a multiple processor system where multiple processors share resources such as memory and storage, a multiple server system where several independent servers operate in parallel (perhaps having shared access to a common database) or any combination. In this, a processor 210 is provided to execute stored programs that are generally stored for execution within a memory 220. The processor 210 can be any processor or a group of processors, for example an Intel Pentium-4® CPU or the like. The memory 220 is connected to the processor and can be any memory suitable for connection with the selected processor 210, such as SRAM, DRAM, SDRAM, RDRAM, DDR, DDR-2, etc. Firmware is stored in firmware storage 225 that is connected to the processor 210 and may include initialization software known as BIOS. This initialization software usually operates when power is applied to the system or when the system is reset. In some embodiments, the software is read and executed directly from the firmware storage 225. Alternately, the initialization software is copied into the memory 220 and executed from the memory 220 to improve performance.

Also connected to the processor 210 is a system bus 230 for connecting to peripheral subsystems such as a network interface 280, a hard disk 240, a CDROM 250, a graphics adapter 260 and a keyboard/mouse 270. The graphics adapter 260 receives commands and display information from the system bus 230 and generates a display image that is displayed on the display 265.

In general, the hard disk 240 may be used to store programs, executable code and data persistently, while the CDROM 250 may be used to load said programs, executable code and data from removable media onto the hard disk 240. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, laser disk, etc. In some embodiments, other devices are connected to the system through the system bus 230 or with other input-output connections. Examples of these devices include printers; mice; graphics tablets; joysticks; and communications adapters such as modems and Ethernet adapters.

The network interface 280 connects the computer-based system to the world-wide-web 10 through a link 285 which is, preferably, a high speed link such as a cable broadband connection, a Digital Subscriber Loop (DSL) broadband connection, a T1 line or a T3 line.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A city coop system for managing the supply, delivery and marketing of goods between at least two cities, the system comprising:
a server computer having a processor, a memory and a network interface, the network interface operatively coupling the server computer to a network;
a database operatively coupled to the server computer;
a city coop management module operating on the server computer and interfacing with the database; and
a first interface between the city coop management module and at least one supplier computer in a supplying city of the at least two cities; and
a second interface between the city coop management module and at least one marketer computer in a marketing city of the at least two cities,
whereas the city coop management module includes a means to manage supplier transactions from the at least one supplier computer using the database to track the supplier transactions and a means to manage marketer transactions from the at least one marketer computer using the database to track the marketer transactions.

2. The city coop system of claim 1, wherein the database includes data regarding shipments, inventories and payments.

3. The city coop system of claim 1, wherein the supplier transactions include order transactions, material logistics transactions and inventory reconciliation transactions.

4. The city coop system of claim 1, wherein the marketer transactions include order transactions, payment transactions and inventory status transactions.

5. A method for connecting at least two cities in a cooperative marketing system, the method comprising:
establishing a plurality of suppliers in at least one supplying city;
establishing a plurality of marketers in at least one marketing city;
shipping goods from the suppliers to the marketers;
marketing the goods by the marketers in the marketing city; and
managing a flow of goods, an inventory of goods and a flow of payments with a city coop manager module operating on a computer system.

6. The method of claim 5, wherein the goods are provided on consignment to the marketers.

7. The method of claim 5, further comprising the steps of:
providing a special order catalog;
allowing a customer to enter an order from the special order catalog through on of the marketer;
managing the order by the city coop manager; and
shipping the order from one of the suppliers to the one of the marketers.

8. The method of claim 5, wherein the plurality of marketers are co-located in a common structure.

9. The method of claim 8, wherein the common structure is a mall provided by a government entity of the at least on marketing city.

10. The method of claim 9, wherein the marketers pay rent to the government entity.

11. A computer based method for connecting at least two cities in a cooperative marketing system, the method comprising:
establishing a plurality of suppliers in at least one supplying city;
establishing a plurality of marketers in at least one marketing city;
shipping goods from the suppliers to the marketers;
marketing the goods by the marketers in the marketing city; and
managing a flow of goods, an inventory of goods and a flow of payments by a city coop manager process operating on a computer system.

12. The method of claim 11, wherein the goods are provided on consignment to the marketers.

13. The method of claim 11, further comprising the steps of:
providing a special order catalog;
allowing a customer to enter an order from the special order catalog through on of the marketer;
managing the order by the city coop manager; and
shipping the order from one of the suppliers to the one of the marketers.

14. The method of claim 11, wherein the plurality of marketers are co-located in a common structure.

15. The method of claim 14, wherein the common structure is a mall provided by a government entity of the at least on marketing city.

16. The method of claim 15, wherein the marketers pay rent to the government entity.

17. A method of doing business in which at least two cities are interfaced in a cooperative marketing system, the method comprising:
establishing a plurality of suppliers in at least one supplying city;
establishing a plurality of marketers in at least one marketing city;
shipping goods from the suppliers to the marketers;
marketing the goods by the marketers in the marketing city;
collecting payments from the marketers;
retaining a percentage of the payments from the marketers;
transferring a remainder of the payments from the marketers to the suppliers; and
managing a flow of goods from the suppliers, an inventory of goods at the marketers and a flow of the payments.

18. The method of doing business in which at least two cities are interfaced in a cooperative marketing system of claim 17, wherein the goods are provided on consignment to the marketers.

19. The method of doing business in which at least two cities are interfaced in a cooperative marketing system of claim 17, the method further comprising the steps of:
providing a special order catalog;
allowing a customer to enter an order from the special order catalog through on of the marketer;
managing the order by the city coop manager; and
shipping the order from one of the suppliers to the one of the marketers.

20. The method of doing business in which at least two cities are interfaced in a cooperative marketing system of claim 17, wherein the plurality of marketers are co-located in a common structure.

21. The method of doing business in which at least two cities are interfaced in a cooperative marketing system of claim 20, wherein the common structure is a mall provided by a government entity of the at least on marketing city.

22. The method of doing business in which at least two cities are interfaced in a cooperative marketing system of claim 21, wherein the marketers pay rent to the government entity.

23. A computer program product for use with a computer system for connecting at least two cities in a cooperative marketing system, the computer program product comprising:
a computer usable medium having computer-readable code means embodied in the medium, the computer-readable code means comprising:
a plurality of computer readable code means for interfacing over a network a city coop manager to a plurality of supplier computers located in a supplier city of the at least two cities;
a plurality of computer readable code means for interfacing over the network the city coop manager to a plurality of marketer computers from a marketer city of the at least two cities;
a plurality of computer readable code means for storing logistics, inventory and payment information into a database; and
a plurality of computer readable code means for processing transactions acted upon by the city coop manager.

24. The computer program product for use with a computer system for connecting at least two cities in a cooperative marketing system of claim 23, wherein the transactions include supplier transactions from the supplier computers, the supplier transactions include order transactions, material logistics transactions and inventory reconciliation transactions.

25. The computer program product for use with a computer system for connecting at least two cities in a cooperative marketing system of claim 23, wherein the transactions include marketer transactions from the marketer computers, the marketer transactions include order transactions, payment transactions and inventory status transactions.
